(19) United States
(12) Patent Application Publication
(10) Pub. No.: US 2013/0273360 A1
(43) Pub. Date: Oct. 17, 2013

(54) DUAL SUBSTRATE DEVICE AND DUAL SUBSTRATE BONDING METHOD

(71) Applicants: WINTEK (CHINA) TECHNOLOGY LTD., Dongguan City (CN); WINTEK CORPORATION, Taichung City (TW)

(72) Inventors: Yun-Ting Chen, Taoyuan County (TW); Yu-Ting Chen, Taoyuan County (TW)

(73) Assignees: WINTEK CORPORATION, Taichung City (TW); Wintek (China) Technology Ltd., Dongguan City (CN)

(21) Appl. No.: 13/853,069

(22) Filed: Mar. 29, 2013

(30) Foreign Application Priority Data
Apr. 12, 2012 (TW) 101112972

(51) Int. Cl. B32B 7/14; B32B 38/00

(52) U.S. Cl. CPC B32B 7/14; B32B 38/145
USPC 428/354; 156/277

(57) ABSTRACT

A dual substrate device includes a first substrate, a second substrate and a first sealant. The first sealant is located between and around the first substrate and the second substrate. The first sealant has at least two wide widths so as to enhance peeling strength of the dual substrate device.

### BACKGROUND OF THE INVENTION

1. Field of the Invention

The invention relates to a dual substrate device and a dual substrate bonding method and, more particularly, to a dual substrate bonding method for forming a sealant with at least two wide widths by a screen printing process and a dual substrate device manufactured by the dual substrate bonding method.

2. Description of the Prior Art

Since electronic products are made lighter, thinner, shorter, and smaller, the substrates of a dual substrate device (e.g. a display panel, a touch panel, etc.) installed on the electronic products are also made thinner and thinner. To enhance resolution of the dual substrate device and to increase active area of the dual substrate device for visual effect, a frame of the dual substrate device is made narrower and narrower. However, reliability (i.e. peeling strength) of the dual substrate device will be influenced by thin substrates and narrow frame. Since so far wide widths of a sealant have to be made smaller and smaller, a head width of a spray nozzle cannot satisfy current conditions already. In order to enhance peeling strength of substrates, viscosity of the sealant has to be increased so that the sealant may be broken or formed as gourd-shaped if the sealant is formed by a conventional dispenser. Furthermore, the conventional dispenser is unstable and the spray nozzle usually cannot spray the sealant out smoothly due to dirt and particles.

### SUMMARY OF THE INVENTION

An objective of the invention is to provide a dual substrate bonding method for forming a sealant with at least two wide widths by a screen printing process and a dual substrate device manufactured by the dual substrate bonding method.

According to an embodiment of the invention, a dual substrate device comprises a first substrate, a second substrate and a first sealant. The first sealant is located between and around the first substrate and the second substrate. The first sealant has at least two wide widths.

According to another embodiment of the invention, a dual substrate bonding method comprises steps of providing a screen plate, wherein a first pattern is formed on the screen plate in advance and the first pattern has at least two wide widths; using the screen plate to coat a first sealant on a periphery of a first substrate by a screen printing process, wherein the first sealant has at least two wide widths corresponding to the first pattern; and bonding a second substrate to the first substrate with the first sealant.

As mentioned in the above, the invention forms the sealant with at least two wide widths by the screen printing process. Compared with the conventional dispenser, the invention utilizes the screen printing process to improve stability and uniformity of the sealant with different wide widths and utilizes the screen plate to change wide width of partial sealant coated around the substrates (e.g. to increase wide width of one side of the sealant corresponding to a driving circuit), so as to enhance peeling strength of the substrates. In other words, since the invention coats the sealant by the screen printing process, the invention can only increase wide width of partial sealant, whose peeling strength has to be enhanced, so that the dual substrate device of the invention can be made as thin as possible.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a dual substrate bonding method according to an embodiment of the invention.

FIG. 2 is a schematic diagram illustrating a screen plate adapted to a screen printing process.

FIG. 3 is a schematic diagram illustrating a first substrate with a first sealant coated thereon.

FIG. 4 is a schematic diagram illustrating a second substrate being bonded to the first substrate with the first sealant so as to form a dual substrate device.

FIG. 5 is a cross-sectional view illustrating the dual substrate device alone line X-X shown in FIG. 4.

FIG. 6 is a schematic diagram illustrating another screen plate adapted to a screen printing process.

FIG. 7 is a schematic diagram illustrating the second substrate being bonded to the first substrate with a first sealant so as to form another dual substrate device.

FIG. 8 is a schematic diagram illustrating another screen plate adapted to a screen printing process.

FIG. 9 is a schematic diagram illustrating the second substrate being bonded to the first substrate with a first sealant so as to form another dual substrate device.

FIG. 10 is a schematic diagram illustrating another screen plate adapted to a screen printing process.

FIG. 11 is a schematic diagram illustrating the second substrate being bonded to the first substrate with the first sealant and a second sealant so as to form another dual substrate device.

FIG. 12 is a schematic diagram illustrating another screen plate adapted to a screen printing process.

FIG. 13 is a schematic diagram illustrating the second substrate being bonded to the first substrate with the first sealant and a second sealant so as to form another dual substrate device.

### DETAILED DESCRIPTION

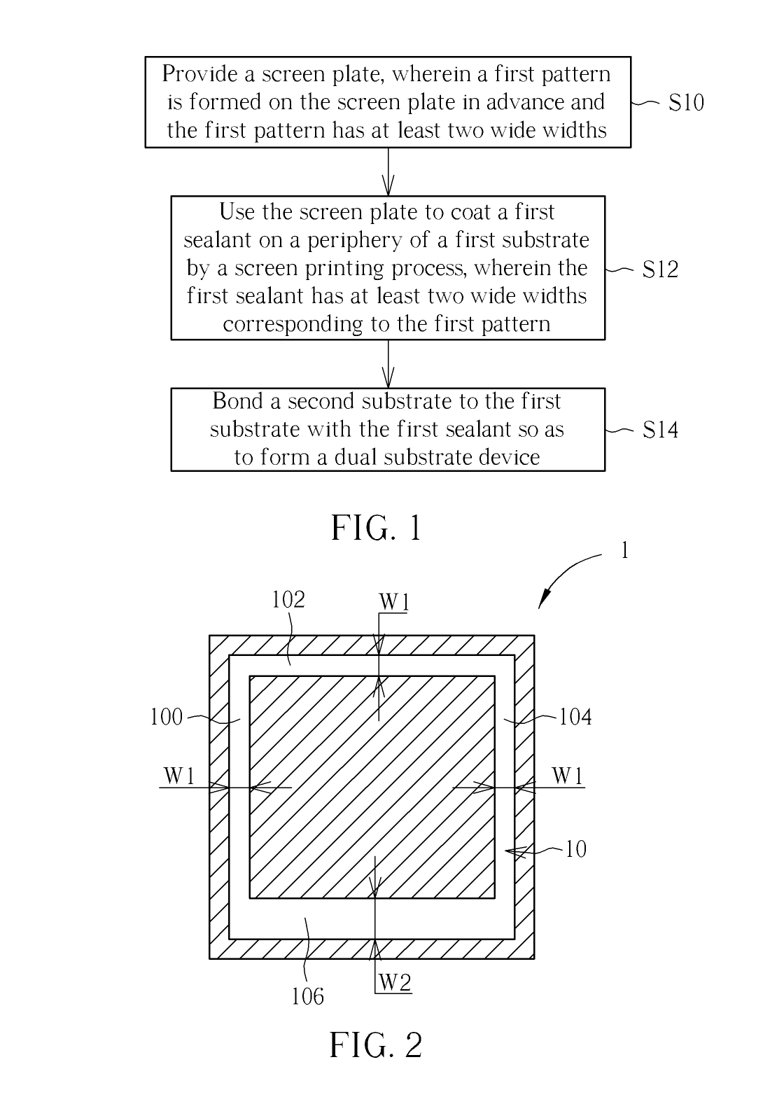

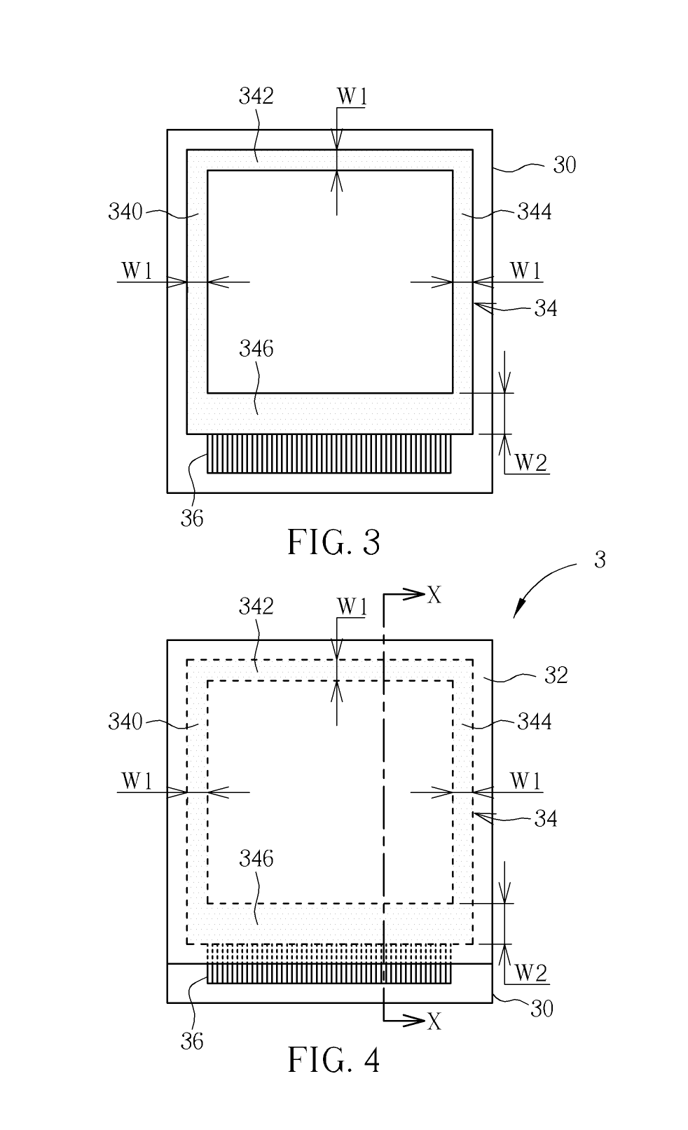

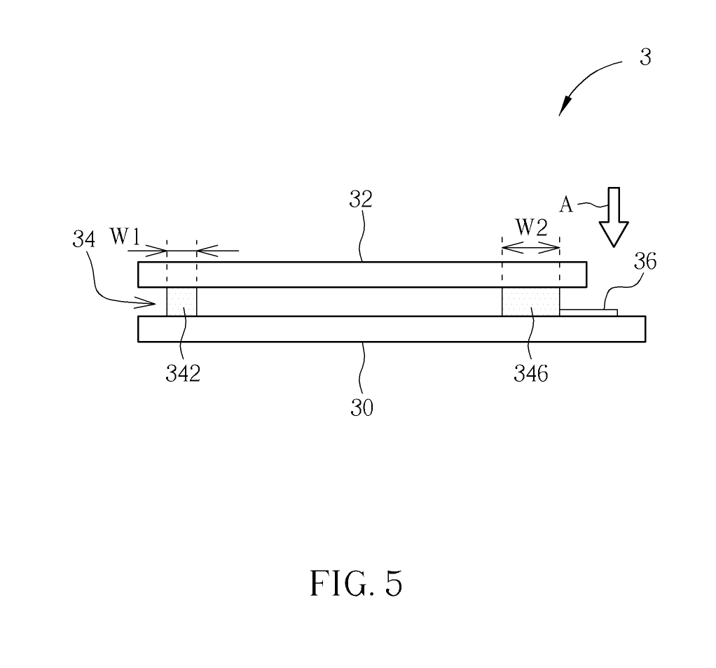

Referring to FIGS. 1 to 5, FIG. 1 is a flowchart illustrating a dual substrate bonding method according to an embodiment of the invention, FIG. 2 is a schematic diagram illustrating a screen plate 1 adapted to a screen printing process, FIG. 3 is a schematic diagram illustrating a first substrate 30 with a first sealant 34 coated thereon, FIG. 4 is a schematic diagram illustrating a second substrate 32 being bonded to the first substrate 30 with the first sealant 34 so as to form a dual substrate device 3, and FIG. 5 is a cross-sectional view illustrating the dual substrate device 3 alone line X-X shown in FIG. 4.

First of all, step S10 is performed to provide a screen plate 1, wherein a first pattern 10 is formed on the screen plate 1 in advance and the first pattern 10 has at least two wide widths W1 and W2, as shown in FIG. 2. In this embodiment, the first pattern 10 is rectangular, wherein wide widths of three sides 100, 102 and 104 are equal to W1 and a wide width of another side 106 is equal to W2. In this embodiment, W2 is larger than W1. In other words, the wide width of the side 106 of the first pattern 10 is larger than the wide widths of the three sides 100, 102 and 104 of the first pattern 10. It should be noted that the shape and type of the first pattern 10 can be determined based on practical applications and are not limited to the embodiment shown in FIG. 2.

Afterward, step S12 is performed to use the screen plate 1 to coat a first sealant 34 on a periphery of a first substrate 30 by a screen printing process, wherein the first sealant 34 has at least two wide widths W1 and W2 corresponding to the first pattern 10, as shown in FIG. 3. In this embodiment, since the first pattern 10 is rectangular, the first sealant 34 is also rectangular correspondingly, wherein wide widths of three sides 340, 342 and 344 of the first sealant 34, which are corresponding to the three sides 100, 102 and 104 of the first pattern 10, are also equal to W1 and a wide width of another side 346 of the first sealant 34, which is corresponding to the side 106 of the first pattern 10, is also equal to W2. Accordingly, the wide width of the side 346 of the first sealant 34 is larger than the wide widths of the three sides 340, 342 and 344 of the first sealant 34.

Step S14 is then performed to bond a second substrate 32 to the first substrate 30 with the first sealant 34 so as to form a dual substrate device 3, as shown in FIGS. 4 and 5.

As shown in FIG. 4, after manufacturing the dual substrate device 3 by the aforesaid dual substrate bonding method, the first sealant 34 is located between and around the first substrate 30 and the second substrate 32, wherein the first sealant 34 has at least two wide widths W1 and W2. It should be noted that the invention may change the shape and type of the first pattern 10 to increase wide width of a specific portion of the first sealant 34, so as to enhance peeling strength of the dual substrate device 3 corresponding to the specific portion. In practical applications, the dual substrate device 3 may be a display panel (e.g. liquid crystal display panel), a touch panel or other devices with two substrates. For example, the invention is also adapted to bond a lower substrate of a touch panel to an upper substrate of a display panel. Furthermore, the first substrate 30 and the second substrate 32 may be, but not limited to, glass substrates or plastic substrates.

As shown in FIGS. 4 and 5, a driving circuit 36 is disposed on the first substrate 30 and adjacent to the side 346 of the first sealant 34 with larger wide width. In general, a force for testing peeling strength is usually imposed on one side close to the driving circuit 36 (as a direction indicated by an arrow A shown in FIG. 5). Therefore, as long as the wide width of the side 346 of the first sealant 34 increases, the peeling strength of the dual substrate device 3 can be enhanced effectively. In other words, the invention can only increase wide width of partial first sealant 34, whose peeling strength has to be enhanced, so that the dual substrate device 3 of the invention can be made as thin as possible.

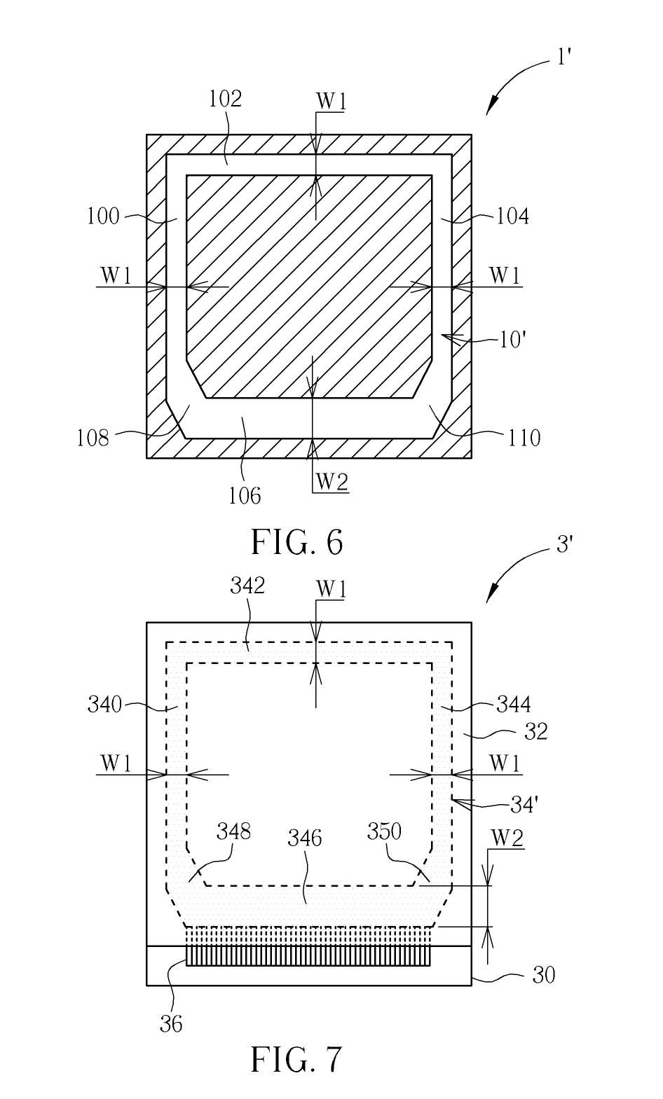

Referring to FIGS. 6 and 7, FIG. 6 is a schematic diagram illustrating another screen plate 1′ adapted to a screen printing process and FIG. 7 is a schematic diagram illustrating the second substrate 32 being bonded to the first substrate 30 with a first sealant 34′ so as to form another dual substrate device 3′. The screen plate 1 provided in the aforesaid step S10 can be replaced by the screen plate 1′ shown in FIG. 6. As shown in FIG. 6, a first pattern 10′ is formed on the screen plate 1′ in advance and the first pattern 10′ has at least two wide widths W1 and W2. The main difference between the screen plate 1′ and the aforesaid screen plate 1 is that at least one corner of the first pattern 10′ of the screen plate 1′ is oblique. In this embodiment, two corners 108 and 110 of the side 106 are oblique, but the invention is not limited to this embodiment. As shown in FIG. 7, after manufacturing the dual substrate device 3′ with the screen plate 1′ by the aforesaid dual substrate bonding method, two corners 348 and 350 of the first sealant 34′ are also oblique. In other words, when at least one corner of the first pattern 10′ of the screen plate 1′ is oblique, at least one corner of the first sealant 34′ is also oblique correspondingly.

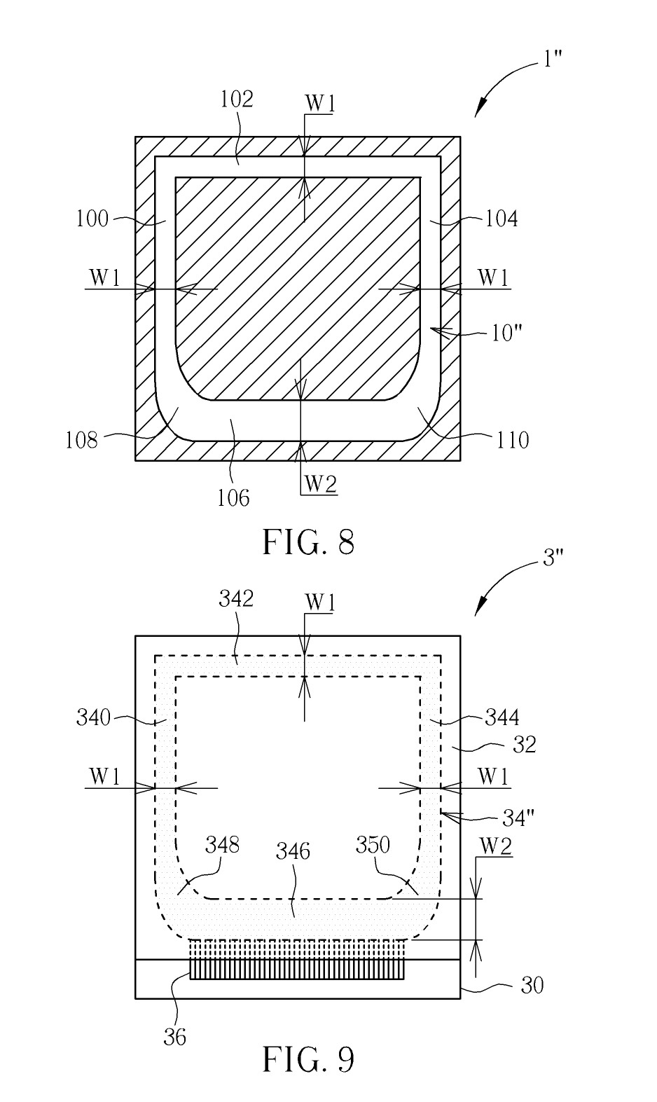

Referring to FIGS. 8 and 9, FIG. 8 is a schematic diagram illustrating another screen plate 1″ adapted to a screen printing process and FIG. 9 is a schematic diagram illustrating the second substrate 32 being bonded to the first substrate 30 with a first sealant 34″ so as to form another dual substrate device 3″. The screen plate 1 provided in the aforesaid step S10 can be replaced by the screen plate 1″ shown in FIG. 8. As shown in FIG. 8, a first pattern 10″ is formed on the screen plate 1″ in advance and the first pattern 10″ has at least two wide widths W1 and W2. The main difference between the screen plate 1″ and the aforesaid screen plate 1 is that at least one corner of the first pattern 10″ of the screen plate 1″ is arc-shaped. In this embodiment, two corners 108 and 110 of the side 106 are arc-shaped, but the invention is not limited to this embodiment. As shown in FIG. 9, after manufacturing the dual substrate device 3″ with the screen plate 1″ by the aforesaid dual substrate bonding method, two corners 348 and 350 of the first sealant 34″ are also arc-shaped. In other words, when at least one corner of the first pattern 10″ of the screen plate 1″ is arc-shaped, at least one corner of the first sealant 34″ is also arc-shaped correspondingly.

The oblique or arc-shaped corners of the first sealant 34′ and 34″ can reduce stress concentration on the corners while testing peeling strength of the dual substrate device 3′ and 3″, so as to enhance peeling strength of the dual substrate device 3′ and 3″ effectively.

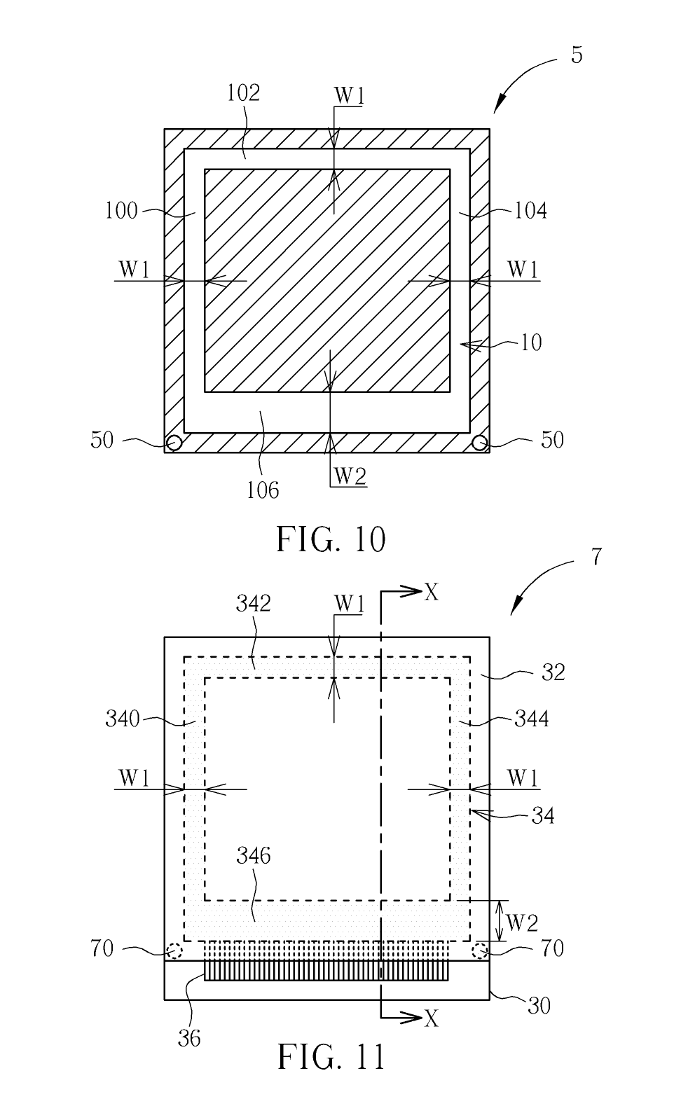

Referring to FIGS. 10 and 11, FIG. 10 is a schematic diagram illustrating another screen plate 5 adapted to a screen printing process and FIG. 11 is a schematic diagram illustrating the second substrate 32 being bonded to the first substrate 30 with the first sealant 34 and a second sealant 70 so as to form another dual substrate device 7. The screen plate 1 provided in the aforesaid step S10 can be replaced by the screen plate 5 shown in FIG. 10. As shown in FIG. 10, the main difference between the screen plate 5 and the aforesaid screen plate 1 is that two second patterns 50 are further formed on the screen plate 5 in advance and adjacent to two corners of the first pattern 10. In this embodiment, the two second patterns 50 are, but not limited to, circular. In this embodiment, the first sealant 34 and two second sealants 70 can be coated on the first substrate 30 simultaneously by the screen printing process in the aforesaid step S12, wherein the two second sealants 70, which are corresponding to the two second patterns 50, are also circular, as shown in FIG. 11. After manufacturing the dual substrate device 7 with the screen plate 5 by the aforesaid dual substrate bonding method, the two second sealants 70 are located between the first substrate 30 and the second substrate 32 and adjacent to two corners of the first sealant 34.

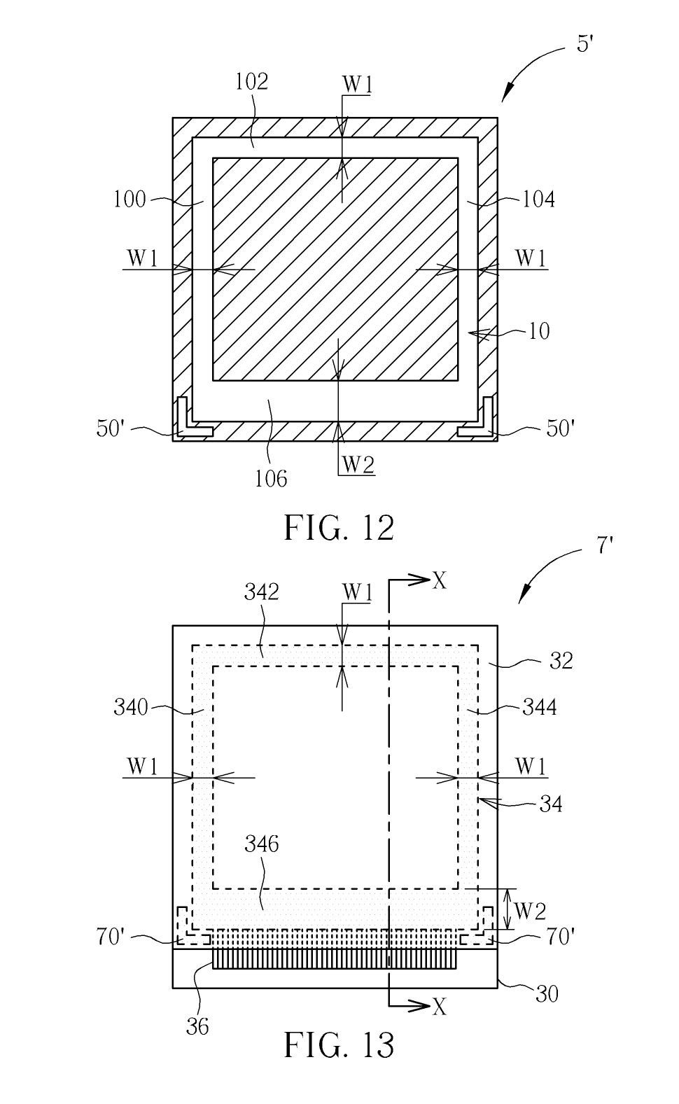

Referring to FIGS. 12 and 13, FIG. 12 is a schematic diagram illustrating another screen plate 5′ adapted to a screen printing process and FIG. 13 is a schematic diagram illustrating the second substrate 32 being bonded to the first substrate 30 with the first sealant 34 and a second sealant 70′ so as to form another dual substrate device 7′. The screen plate 1 provided in the aforesaid step S10 can be replaced by the screen plate 5′ shown in FIG. 12. As shown in FIG. 12, the main difference between the screen plate 5′ and the aforesaid screen plate 1 is that two second patterns 50′ are further formed on the screen plate 5′ in advance and adjacent to two corners of the first pattern 10. In this embodiment, the two second patterns 50′ are, but not limited to, strip-shaped. In this embodiment, the first sealant 34 and two second sealants 70′ can be coated on the first substrate 30 simultaneously by the screen printing process in the aforesaid step S12, wherein the two second sealants 70′, which are corresponding to the two second patterns 50′, are also strip-shaped, as shown in FIG. 13. After manufacturing the dual substrate device 7′ with the screen plate 5′ by the aforesaid dual substrate bonding method, the two second sealants 70′ are located between the first substrate 30 and the second substrate 32 and adjacent to two corners of the first sealant 34.

Since the first sealant 34 has to be coated on specific position with specific precision, a distance between an edge of the substrate and the first sealant 34 has to conform to a specific value (about 200 μm). Therefore, the second sealants 70 and 70′ adjacent to two corners of the first sealant 34 can further enhance peeling strength of the dual substrate devices 7 and 7′ so as to prevent the two substrates from peeling.

As mentioned in the above, the invention forms the sealant with at least two wide widths by the screen printing process. Compared with the conventional dispenser, the invention utilizes the screen printing process to improve stability and uniformity of the sealant with different wide widths and utilizes the screen plate to change wide width of partial sealant coated around the substrates (e.g. to increase wide width of one side of the sealant corresponding to a driving circuit), so as to enhance peeling strength of the substrates. In other words, since the invention coats the sealant by the screen printing process, the invention can only increase wide width of partial sealant, whose peeling strength has to be enhanced, so that the dual substrate device of the invention can be made as thin as possible. Furthermore, the invention may form oblique or arc-shaped corners on the sealant to reduce stress concentration on the corners while testing peeling strength of the dual substrate device, so as to enhance peeling strength of the dual substrate device effectively. Moreover, the invention may add circular or strip-shaped sealants on the corners so as to enhance peeling strength of the dual substrate device further.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual substrate device comprising:
a first substrate;
a second substrate; and
a first sealant located between and around the first substrate and the second substrate, the first sealant having at least two wide widths.

2. The dual substrate device of claim 1, wherein a wide width of one side of the first sealant is larger than a wide width of each of other three sides of the first sealant.

3. The dual substrate device of claim 2, wherein a driving circuit is disposed on the first substrate and adjacent to the side of the first sealant with larger wide width.

4. The dual substrate device of claim 1, wherein at least one corner of the first sealant is oblique or arc-shaped.

5. The dual substrate device of claim 1, further comprising two second sealants located between the first substrate and the second substrate and adjacent to two corners of the first sealant.

6. The dual substrate device of claim 5, wherein the two second sealants are circular or strip-shaped.

7. A dual substrate bonding method comprising:
providing a screen plate, wherein a first pattern is formed on the screen plate in advance and the first pattern has at least two wide widths;
using the screen plate to coat a first sealant on a periphery of a first substrate by a screen printing process, wherein the first sealant has at least two wide widths corresponding to the first pattern; and
bonding a second substrate to the first substrate with the first sealant.

8. The dual substrate bonding method of claim 7, wherein a wide width of one side of the first pattern is larger than a wide width of each of other three sides of the first pattern such that a wide width of one side of the first sealant is larger than a wide width of each of other three sides of the first sealant.

9. The dual substrate bonding method of claim 7, wherein at least one corner of the first pattern is oblique or arc-shaped so that at least one corner of the first sealant is oblique or arc-shaped.

10. The dual substrate bonding method of claim 7, wherein two second patterns are formed on the screen plate in advance and adjacent to two corners of the first pattern, the dual substrate bonding method further comprising:
using the screen plate to coat two second sealants on the first substrate by the screen printing process, wherein the two second sealants are corresponding to the two second patterns and adjacent to two corners of the first sealant.

11. The dual substrate bonding method of claim 10, wherein the two second patterns are circular or strip-shaped so that the two second sealants are circular or strip-shaped.
